(19) United States
(12) Patent Application Publication
(10) Pub. No.: US 2005/0239412 A1
(43) Pub. Date: Oct. 27, 2005

(54) Method for controlling data transmission in wireless networks

(75) Inventor: Thomas Kelz, Germendorf (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: fg Microtec GmbH, Munich (DE)

(21) Appl. No.: 11/102,793

(22) Filed: Apr. 11, 2005

Related U.S. Application Data
(63) Continuation-in-part of application No. PCT/EP03/11198, filed on Oct. 9, 2003.

(30) Foreign Application Priority Data
Oct. 11, 2002 (DE) 102 47 581.4

(51) Int. Cl. H04Q 7/20

(52) U.S. Cl. 455/67.11; 455/115.1

(57) ABSTRACT

The quality of radio links, such as UMTS radio links, is predicted by measuring at least one quality-related parameter of the radio link and analyzing commands for controlling the radio link that pertain to the quality-related parameters. Preferably, the quality-related parameter measures or determines the quality of the uplink or downlink. The determined parameters are transmitted to an algorithm which can make predictions about the future. Preferably, the algorithm represents a multidimensional stochastic algorithm which utilizes covariance matrices. Other algorithms can use neural networks, genetic algorithms, and/or simulated annealing.

### CROSS-REFERENCE TO RELATED APPLICATION

This application is a continuation-in-part of PCT International Application No. PCT/EP03/11198, filed Oct. 9, 2003, incorporated herein by reference, which claims the priority of German Patent Application No. 102 47 581, filed on Oct. 11, 2002.

### FIELD OF THE INVENTION

The invention relates to a method for predicting the quality of a wireless link and controlling data transmission in a wireless network. The invention relates in particular to a method for predicting quality fluctuations in UMTS and GPRS links. In this case, known measured values and reactions of the base station are taken into account.

### BACKGROUND OF THE INVENTION

In order to improve transmission rates in wireless communication, it is advantageous to know how the quality will develop over the course of the transmission time. This is of very major interest for mobile devices, since major quality fluctuations can occur as a result of movements. The predictions make it possible to decide whether the transmission should be sped up before the quality becomes poorer, or whether smaller amounts of data should be transmitted for the time being and the transmission performance can be sped up at a later time in the event of better quality.

### DESCRIPTION OF RELATED ART

Ref. [1] (see list at the end of the description) discloses a method which determines and/or predicts the quality of a wireless link, in particular of the uplink, i.e. the link when sending data from the mobile device to the base station. The 3GPP Standard (see Ref. [2]) discloses a method by means of which the quality of the downlink (data transmission from the base station to the mobile device) can be determined.

### OBJECT OF THE INVENTION

The aim of the invention is to improve the transmission performance on the basis of a prediction of the quality of the wireless link. Values are in each case taken into account which are simple to determine and are correlated with one another.

### SUMMARY OF THE INVENTION

This object is achieved by the inventions as claimed in the independent claims. Advantageous embodiments are described in the dependent claims.

In general, the invention consists of a method for controlling the quality of a wireless link, in particular a UMTS wireless link, in which a mobile device is involved.

First, at least one quality value of the wireless link is measured. In the preferred embodiment, the quality value measures or determines the quality of the uplink or of the downlink. The measurement can either be made by the mobile device or by a base station.

This measured at least one quality value is handed over to an algorithm for predicting the quality of the wireless link. The algorithm not only analyzes the quality value, but additionally analyzes commands for controlling the wireless link, whereby the commands are related to the at least one quality value.

The algorithm is executed on the mobile device. Thus, the mobile device itself controls the quality of the wireless link and not the base station. In particular, the mobile device is able to control the quality of the uplink without having to rely on calculations being made in the base station. This way, the mobile device is able to perform quality of service management e.g. for the uplink.

On the basis of the prediction made by the algorithm, further transmission parameters of the wireless link are adapted, in addition to adapting the transmission power. These are, e.g., the block size, the codec, the forward error correction (FEC), the header compression method and/or the transmission delay. In this way, the transmission of data over the wireless link can be adapted in a flexible way to the quality of the wireless link. If the quality is low, e.g. the amount of data transmitted is reduced by using a different codec with a higher degree of compression of the data, and vice versa.

The prediction algorithm is preferably a multidimensional stochastic algorithm which, in particular, comprises covariance matrices. Other algorithms may use neural networks, genetic algorithms and/or simulated annealing.

In the preferred embodiment, the commands for controlling the wireless link are TPC commands (transmission power control commands), which are sent by the base station and received by the mobile device. TPC commands are used for adapting the transmission power of the mobile device. Their values are +1 or −1, instructing the mobile device to increase or decrease its transmission power by 1 db. The base station sends approximately 1500 TPC commands per second. The aim of these commands is to adapt the SIR (signal to interference ratio) by either increasing or decreasing the transmission power (TX power) of the mobile device. In the preferred embodiment, 30 TPC message blocks are combined within a TTI of 20 ms. The TTI time-scale stands for transmission time interval and is 10 or 20 ms per interval.

Preferably, the 30 TPC commands are averaged in order to decrease the number of transmission power changes for the mobile device. Not every TPC command is immediately executed. Generally, if a TPC commands is +1, the transmission power of the mobile device is to be increased by Δ TPC. Δ TPC describes the step for increasing/decreasing the transmission power, e.g. 1 db. Δ TPC is set by the base station. Two different PCAs (Power Control Algorithm) are specified in the UMTS specification in order to react to TPC commands. Depending on the used PCA, the mobile device increases or decreases its transmission power with every TPC command or summarizes/averages several TPC commands and uses the result to decide whether the power is to be increased or decreased. The used PCA is set by the base station. Preferably, the used PCA uses different statistical weights for the individual TPC commands during the averaging with the younger values having a higher weight than the older ones. This makes it possible to identify short-term changes.

The loss of signal during transmission is calculated on the basis of the transmission power TX and the received power RX on the downlink. It is assumed, that the loss of the uplink is identical to the loss of the downlink. Thus, calculating the loss of the downlink gives a good estimate of the loss of the uplink.

In a further embodiment, the block error rate (BLER) is taken into account by the algorithm for predicting the quality of the link, which is preferably the uplink.

Further components of the invention are an electronic circuit, software for a mobile communication device, a mobile communication device, in particular a mobile telephone or PDA, and a data storage medium for a mobile communication device, in particular a mobile telephone or a PDA.

### BRIEF DESCRIPTION OF THE DRAWINGS

Other objects and advantages of the present invention may be ascertained from a reading of the specification and the appended claims in conjunction with the drawings.

For a more complete understanding of the present invention, reference is established to the following description made in connection with accompanying drawings in which:

FIG. 1 shows a block diagram of the algorithm for predicting the SIR (signal to interference ratio).

### DETAILED DESCRIPTION OF THE PREFERRED EMBODIMENTS

The method is preferably used to control the uplink quality of a wireless link.

The following parameters or quality values can be measured on the mobile device for the downlink (DL). The measurements are carried out by the mobile device:
the BLER (Block Error Rate, see [3]),
the CPICH RSCP (received energy per chip divided by the power density in the band, see [3]), and
the UE TX Power (the UE transmission power, see [3]). UE stands for User Equipment, a term which is used in the UMTS specification for the mobile device.

Furthermore, information is provided by the base station and is transmitted by the SIB (System Information Block). This information includes:
UL Interference (Uplink Interference, see [2]),
Δ TPC (step in db for changing transmit power, see [2]),
PCA (Power Control Algorithm 1 or 2, see [2]),
Max. allowed UL TX Power (adjusted by the base station dynamically according to the load of the cell, see [2]),
CPICH TX Power, (Transmit Power of the base station, see [2]).

These pieces of information are broadcast information; they are valid for all mobile devices within the cell at a given time.

In the prior art, the quality of the uplink is measured by the base station and the quality of the downlink is measured by the mobile device. The measurements made by the mobile device concerning the downlink quality are transmitted to the base station so that the base station can control the quality of the downlink. However, the measurements performed by the base station concerning the uplink quality are not transmitted to the mobile device. The mobile device is, thus, not able to control the quality of the uplink in the prior art. The base station controls the behaviour of the mobile device by sending TPC commands. One of the objects of the invention is to enable the mobile device to control the quality of the uplink.

What we are missing to this end up to here is information about the uplink quality relevant specifically for the mobile device in question. The only information available to this end are the TPC commands.

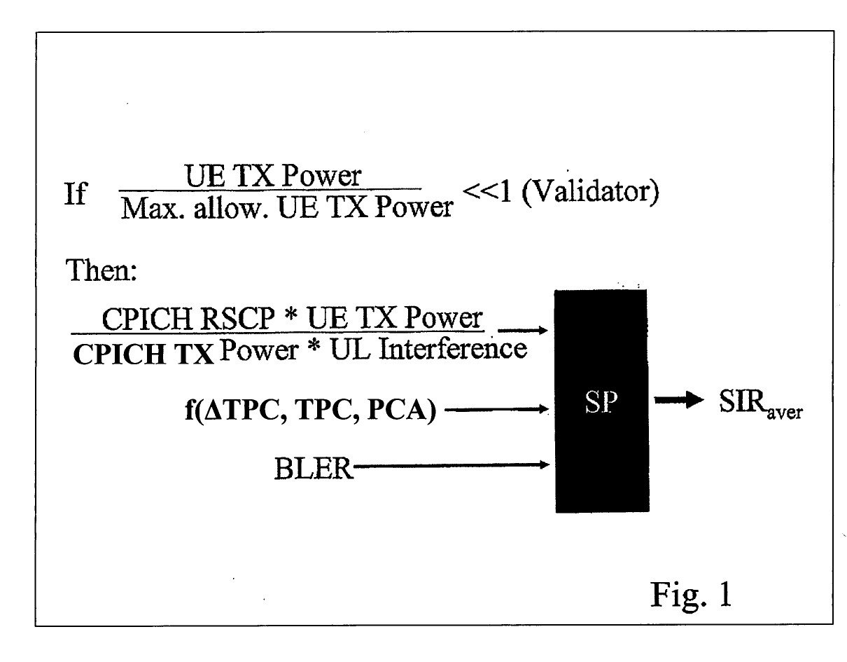

Reference is now made to FIG. 1. To predict the quality of the wireless link, the SIR of the uplink is estimated in the preferred embodiment.

It is assumed that the losses in the uplink and downlink are identical. It is, thus, possible to estimate, that the uplink signal power loss is correlated with the downlink signal power loss. The transmitted power (TX) and the received power (RX) of the signal sent by the base station are known. The loss is obtained as a percentage by the division:
CPICH RSCP/CPICH TX Power.
Multiplication by the transmission power:
(CPICH RSCP/CPICH TX Power)*UE TX Power
results in an estimated value for the received signal power at the base station. A further division by the uplink interference results in the estimated uplink signal-to-interference ratio:

$$\frac{( ( CPICH RSCP / CPICH TX Power ) * UE TX Power )}{UL interference}$$

In the preferred embodiment, this is the first value which is included in the prediction algorithm.

The TPC commands are the second parameter. The base station generally sends 1500 TPC commands per second. The aim is to adapt the SIR of the UE by increasing or decreasing the UE TX Power. The TPC commands are analyzed according to the power control algorithm (PCA) and then multiplied with the Δ TPC value.

In a first embodiment, PCA 1 can be used, which means every TPC command results in a change of the transmission power. Let Δ TPC be set to 5 db. If the TPC commands are (1, −1, 1, 1), the change in transmission power would be (5 db, −5 db, 5 db, 5 db).

In the preferred embodiment, 30 TPC commands (with a TTI of 20 ms) are used at a time. These blocks are averaged and weighted statistically by multiplication with an exponential weighting factor f in order to give the newer values a higher importance than the older ones.

A third value for statements relating to a slow change in the link quality is the BLER.

Further or other input parameters for the predictions could be chosen. However, the three parameters described have proven to be optimal.

All these described parameters are used as input parameters for the multidimensional stochastic algorithm which, preferably, comprises covariance matrices to estimate correlations between the measured (actual) quality values and the resulting future quality of the uplink quality. These correlations are used for the prediction. The results are predictions which are describing the quality of the uplink in the near future. The predictions describe the quality in terms of predicted values for quality parameters like, e.g., the BLER, the SIR, or the BER (bit error rate).

A decision-maker uses these predictions to adapt different parameters for controlling the uplink traffic according to the predicted quality of the uplink. These parameters are, e.g., the block size, the codec, the forward error correction (FEC), the header compression method and/or the transmission delay. The decisions of the decision-maker are taken using a lookup-table that uses the predicted quality parameters as input parameters and has the new values for the control parameters as output.

The decisions taken in the way described above have proven to be reliable if the UE transmission power is reasonably below the maximum allowed uplink transmission power. Therefore, the ratio
(UE TX Power)/(max allowed UL TX Power)
is observed. If this ratio tends to 1, it confirms that the cell is heavily loaded or that the wireless link conditions are poor. It is possible to identify from this ratio that the signal at the base station is not reaching the intended SIR because the maximum permissible transmission power is being used. In this case, in some circumstances, predictions are not very worthwhile, but it is known that the conditions are very poor and that the parameters must be adjusted appropriately. Therefore, the transmission parameters are adapted to values of a very poor link quality. The new parameters must take into account the need to achieve the best possible reliability for the packets, with the best FEC (forward error correction) and the smallest packets. Therefore, e.g., a codec is chosen requiring a very small bandwidth. These decisions are taken by the decision-maker. They are not based on predictions but on know-how stored in a lookup-table.

If the above stated ratio reaches anew a value reasonably lower than 1, the decision-maker turns back to the prediction based decisions to make more gradual changes to the parameters controlling the uplink traffic.

While the present inventions have been described and illustrated in conjunction with a number of specific embodiments, those skilled in the art will appreciate that variations and modifications may be made without departing from the principles of the inventions as herein illustrated, as described and claimed. The present inventions may be embodied in other specific forms without departing from their spirit or essential characteristics. The described embodiments are considered in all respects to be illustrative and not restrictive. The scope of the inventions are, therefore, indicated by the appended claims, rather than by the foregoing description. All changes which come within the meaning and range of equivalence of the claims are to be embraced within their scope.

1. A method for controlling the quality of a wireless link, in particular a UMTS wireless link, in which a mobile device is involved, comprising the following steps:
a) measuring at least one quality value of the wireless link;
b) handing the measured at least one quality value over to an algorithm for predicting the quality of the wireless link;
c) whereby the algorithm additionally analyzes commands for controlling the wireless link, whereby the commands are related to the at least one quality value;
d) executing the algorithm on the mobile device;
e) adapting transmission parameters of the wireless link, in addition to adapting the transmission power, on the basis of the prediction made by the algorithm.

2. The method as claimed in claim 1, characterized in that the method is used for controlling the quality of the uplink of a wireless link.

3. The method as claimed in claim 1, characterized in that the commands adapt the transmission power of the mobile device, and are preferably TPC commands.

4. The method as claimed in claim 1, characterized in that the commands are evaluated and weighted in a temporal window.

5. The method as claimed in claim 1, characterized in that the at least one quality value measures the quality of the uplink and/or of the downlink of the wireless link.

6. The method as claimed in claim 1, characterized in that the uplink transmission power loss is calculated on the basis of the transmission power and the received power in the downlink.

7. The method as claimed in claim 1, characterized in that transmission parameters adapted on the basis of the prediction made by the algorithm are the block size, the codec, the forward error correction, the header compression method and/or the transmission delay.

8. The method as claimed in claim 1, characterized in that the algorithm for predicting the quality of the wireless link is a multidimensional stochastic algorithm which uses, in particular, covariance matrices, neural networks, genetic algorithms and/or simulated annealing.

9. An electronic circuit, characterized by means which implement a method as claimed in claim 1.

10. Software for a mobile communication device, in particular a mobile telephone or PDA, characterized in that a method as claimed in claim 1 is implemented.

11. A data storage medium for a mobile communication device, in particular a mobile telephone or PDA, characterized by the storage of software as claimed in the preceding software claim.

12. At least one of an operating system, a computer readable medium having stored thereon a plurality of computer-executable instructions, a co-processing device, a computing device and a modulated data signal carrying computer executable instructions for performing the method of claim 1.

13. A mobile communication device, characterized by a device which allows a method as claimed in claim 1 to be carried out.
